(19) United States
(12) Patent Application Publication
(10) Pub. No.: US 2017/0316064 A1
(43) Pub. Date: Nov. 2, 2017

(54) CRITICAL EVENT ASSISTANT

(71) Applicant: INTHINC TECHNOLOGY SOLUTIONS, INC., Salt Lake City, UT (US)

(72) Inventors: Jonathan Corey Catten, Holladay, UT (US); Oliver Neil, Sandy, UT (US)

(21) Appl. No.: 15/139,520

(22) Filed: Apr. 27, 2016

(51) Int. Cl. G06F 17/30

(52) U.S. Cl. CPC G06F 17/30554; G06F 17/30292

(57) ABSTRACT

Embodiments are directed to providing event context assistance. In one scenario, a computer system detects the occurrence of a specified event that has an associated level of priority. The computer system determines that the level of priority for the specified event is sufficient to trigger retrieval of data from a data store, and further evaluates the specified event using the retrieved data to create an event data structure that provides relevant contextual information related to the specified event. The computer system then provides the created event data structure to a user or other entity.

### BACKGROUND

Computers and smartphones have become ubiquitous in today's society. These devices are designed to run software applications, which interact with computer hardware to perform desired functions. For instance, software applications may perform business applications, provide entertainment, facilitate turn-by-turn navigation, and perform many other types of tasks. In some cases, software applications may be designed to interact with other computing systems. Such communications can occur over different types of radios which are integrated into devices such as smartphones. Using such communications, computers and other devices can access vast stores of information. This information may be used in a variety of contexts including machine learning, analytics and big data applications.

### BRIEF SUMMARY

Embodiments described herein are directed to providing event context assistance. In one embodiment, a computer system detects the occurrence of a specified event that has an associated level of priority. The computer system determines that the level of priority for the specified event is sufficient to trigger retrieval of data from one or multiple data stores, and further evaluates the specified event using the retrieved data to create an event data structure that provides relevant contextual information related to the specified event. The computer system then provides the created event data structure to a user or other entity.

In another embodiment, a graphical user interface is provided on a computer system. The graphical user interface (GUI) includes the following: an event context investigation overview that allows users to view and evaluate contextual information related to an event, a first event element representing the event, where the first event element has information identifying the event, and a second event element that includes various interactive elements that allow a user to drill down into contextual information displayed in the event element to identify additional contextual information related to the event. The computer system providing the GUI tracks inputs provided by the user to determine which event elements are selected by the user and which contextual information is determined to be relevant to the user. This allows future event elements to be custom generated and/or custom sorted or arranged for the user based on the tracked inputs.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including providing event context assistance.

FIG. 2 illustrates an embodiment of a graphical user interface that provides event context assistance.

FIG. 3 illustrates an example chart that shows driving data and its various sources.

FIG. 4 illustrates an overview of the flow of event information into displayable context information, and further flow into an event report.

FIG. 5 illustrates the occurrence of two events of the same type with different data preferences and different event reports.

FIG. 6 illustrates a flowchart of an example method for providing event context assistance.

### DETAILED DESCRIPTION

Embodiments described herein are directed to providing event context assistance. In one embodiment, a computer system detects the occurrence of a specified event that has an associated level of priority. The computer system determines that the level of priority for the specified event is sufficient to trigger retrieval of data from one or multiple data stores, and further evaluates the specified event using the retrieved data to create an event data structure that provides relevant contextual information related to the specified event. The computer system then provides the created event data structure to a user or other entity.

In another embodiment, a graphical user interface is provided on a computer system. The graphical user interface (GUI) includes the following: an event context investigation overview that allows users to view and evaluate contextual information related to an event, a first event element representing the event, where the first event element has information identifying the event, and a second event element that includes various interactive elements that allow a user to drill down into contextual information displayed in the event element to identify additional contextual information related to the event. The computer system providing the GUI tracks inputs provided by the user to determine which event elements are selected by the user and which contextual information is determined to be relevant to the user. This allows future event elements to be custom generated for the user based on the tracked inputs.

Embodiments described herein may implement various types of computing systems. These computing systems are now increasingly taking a wide variety of forms. Computing systems may, for example, be mobile phones, electronic appliances, laptop computers, tablet computers, wearable devices, desktop computers, mainframes, vehicle-based computers, head units, tracking devices, and the like. As used herein, the term “computing system” includes any device, system, or combination thereof that includes at least one processor, and a physical and tangible computer-readable memory capable of having thereon computer-executable instructions that are executable by the processor. A computing system may be distributed over a network environment and may include multiple constituent computing systems.

A computing system typically includes at least one processing unit and memory. The memory may be physical system memory, which may be volatile, non-volatile, or some combination of the two. The term “memory” may also be used herein to refer to non-volatile mass storage such as physical storage media or physical storage devices. If the computing system is distributed, the processing, memory and/or storage capability may be distributed as well. Embodiments described herein may be implemented on single computing devices, networked computing devices, or distributed computing devices such as cloud computing devices.

As used herein, the term “executable module” or “executable component” can refer to software objects, routines, methods, or similar computer-executable instructions that may be executed on the computing system. The different components, modules, engines, and services described herein may be implemented as objects or processes that execute on the computing system (e.g., as separate threads).

As described herein, a computing system may also contain communication channels that allow the computing system to communicate with other message processors over a wired or wireless network. Such communication channels may include hardware-based receivers, transmitters or transceivers, which are configured to receive data, transmit data or perform both.

Embodiments described herein also include physical computer-readable media for carrying or storing computer-executable instructions and/or data structures. Such computer-readable media can be any available physical media that can be accessed by a general-purpose or special-purpose computing system.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computing system to implement the disclosed functionality of the embodiments described herein. The data structures may include primitive types (e.g. character, double, floating-point), composite types (e.g. array, record, union, etc.), abstract data types (e.g. container, list, set, stack, tree, etc.), hashes, graphs or other any other types of data structures.

As used herein, computer-executable instructions comprise instructions and data which, when executed at one or more processors, cause a general-purpose computing system, special-purpose computing system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, vehicle-based computers, head units, tracking devices,and the like. The embodiments herein may also be practiced in distributed system environments where local and remote computing systems, which are linked (either by hardwired data links, wireless data links, or by a combination of hardwired and wireless data links) through a network, both perform tasks. As such, in a distributed system environment, a computing system may include a plurality of constituent computing systems. In a distributed system environment, program modules may be located in both local and remote memory storage devices.

Those skilled in the art will also appreciate that the embodiments herein may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

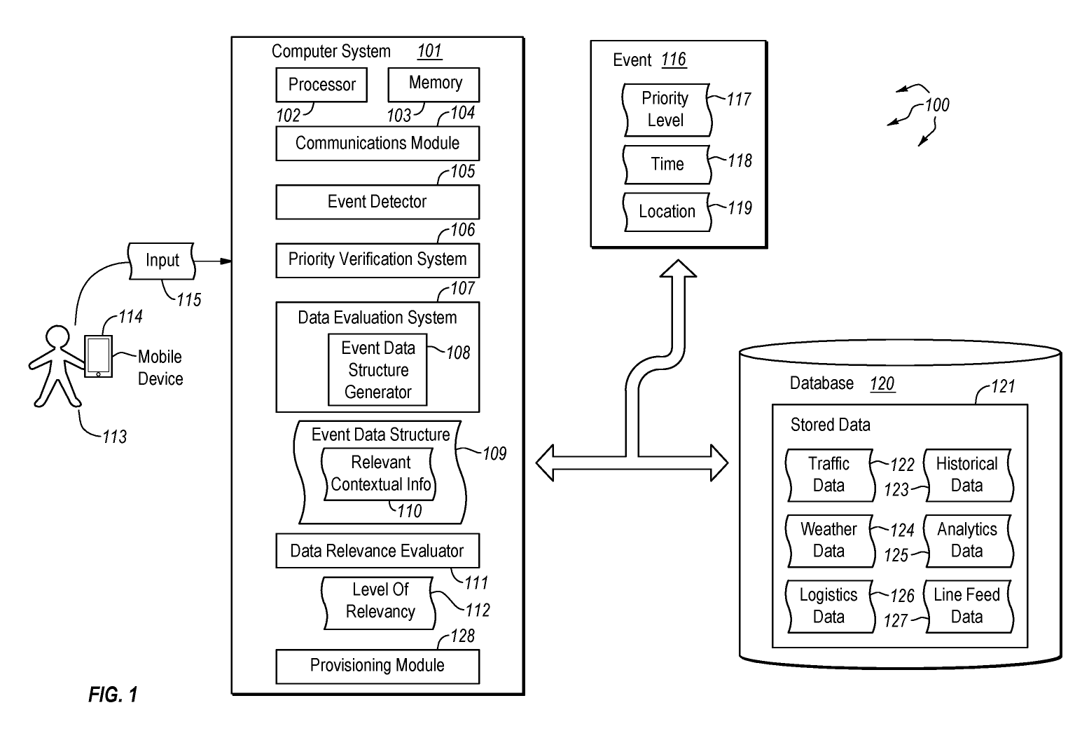

Referring to the figures, FIG. 1 illustrates a computer architecture 100 in which at least one embodiment described herein may be employed. The computer architecture 100 includes a computing system 101. The computing system 101 may be any type of local or distributed computing system, including a cloud computing system. The computing system 101 includes a hardware processor 102 and memory 103. The computing system 101 further includes modules for performing a variety of different functions. For instance, the communications module 104 of computer system 101 may be configured to communicate with other computing systems over a network. The communications module 104 may thus include any wired or wireless communication means that can receive and/or transmit data to or from other computing systems. The communications module 104 may be configured to interact with databases (e.g. 120), mobile computing devices (such as mobile phones or tablets), embedded devices or other types of computing systems.

For example, the computer system 101 may be configured to interact with user 113 and/or mobile device 114. In some embodiments, the user 113 interacts with computer system 101 using mouse, keyboard, touch gestures, or other forms of input. In such cases, the computer system 101 may be, for example, a desktop computer and the user 113 may be a driver, administrator, or fleet manager. Still further, the user 113 could be an insurer, third party clearing house or any other type of user. In some cases, the user 113 may interact with the computer system 101 through the mobile device 114 (e.g. a smart phone, tablet, laptop, wearable device or other computer system). The mobile device 114 may be an extension of the computer system 101, or may itself be the computer system 101.

In some embodiments, the computer system 101 includes a communications module 104 with a hardware transceiver, as well as an event detector 105 configured to detect the occurrence of specified events (e.g. 116). These specified events may have an associated level of priority 117. As used herein, the terms “event” or “specified event” refer to something that has happened and can be quantified as an event. An event may occur in different contexts, and within those contexts the event may have a different priority level.

For instance, in the field of vehicle traffic, an event may be a wreck, a traffic jam, a departure, an arrival or other event. Each wreck, traffic jam, departure or arrival may include its own priority level. For example, in some cases, a fleet manager may note the arrival and departure times of semi-trucks or company vehicles. Other information associated with the event, such as the time 118 the event occurred, or the location 119 of the event 116, may be noted in addition to the event. This additional information may be stored in a data store (e.g. stored data 121) such as database 120.

The database 120 may be a single database, or multiple databases, each of which may be local or remote, and can include a cloud database. In some cases, for example, the computer system 101 may communicate with a weather database and a separate traffic database. Each database may use its own data format or storage schema. When receiving and implementing this data (e.g. in the creation of an event report), the computer system 101 may change data formats and/or schemas to combine the data into a data type understood by the computer system 101 and/or the database 120.

It will be understood that many different events and different types of events may be documented and stored using system 100 of FIG. 1. Each event may have a plethora of data stored with it or associated with it. This stored data 121 may have different levels of relevancy to different users. For example, if a traffic event occurs, a user may wish to see traffic flow data 122, historical data 123, weather data 124, analytics data 125, logistics data 126 and/or live feed data 127. Still further, the user may wish to see other data not listed above. Indeed, the listing of data types in stored data 121 is not a comprehensive list, and one skilled in the art will recognize that substantially any type of data may be stored and associated with an event or group of events.

In the embodiments herein, traffic data 122 or traffic flow data may refer to information indicating how the traffic was flowing prior to the event, or exactly at the time of the event, or at any period prior to the event. If the event occurs at an intersection, the traffic flow data 122 may indicate the flow of traffic through that intersection, it may indicate the volume of traffic at the time of the event or it may indicate unusual patterns associated with traffic flow at that intersection. The historical data 123 may indicate which events have occurred in the past at a particular location, or at a particular time or with a particular vehicle or driver. The historical data may provide insight on whether similar types of events have occurred before at that location or at other locations such as nearby intersections. The weather data 124 may indicate the status of the weather in the location of the event at the time of the event. The weather data 124 may include actual weather readings (such as temperature, wind speed, precipitation, humidity, visibility conditions, etc.) as well as forecasted weather information or historical weather information.

Analytics data 125 may represent analytical analysis of the current event and/or past events. The analytics data 125 (as well as any of the other data) may be provided by a third party such as a company or government entity. The analytics may provide statistical or other analyses of the event or similar events, and may be used to show patterns or anomalies. The logistics data 126 may include, for traffic events, vehicle information including vehicle type (e.g. year, make and model), vehicle service records (e.g. indicating whether brakes and tires are operating within expectations), indications of whether the vehicle was towing a trailer, indications of passengers on board, cell phone use, speed and direction of the vehicle, and other factors. The live feed data 127 may include video data from an intersection camera or smart phone, video data from an in-vehicle camera or smart phone, audio feed data from a cell phone or other device with a microphone, satellite data or other types of live feed data. Each type of data may provide information that may be useful to different users in reviewing the event.

This information, however, may have different levels of importance or priority to different users. As such, the priority verification system 106 of computer system 101 is configured to determine the priority level for any given event. In some cases, the priority level 117 is specific to a given user, indicating which types of information that user believes are important in conjunction with that event. The priority verification system 106 may be set up so that information associated with the event is not retrieved at the occurrence of each event. Rather, the priority verification system 106 may determine whether the level of priority for a given event 116 is sufficient to trigger retrieval of data from the database 120.

For instance, using historical inputs 115 from user 113, the priority verification system 106 may assess whether the user has viewed similar events in the past, or whether the user has skipped or ignored those events. If the priority verification system 106 determines that the user has historically been interested in events such as event 116, it may determine that the priority level is high enough to retrieve stored data 121 from the database 120. The user's historical inputs may also be used to determine which types of stored data 121 to retrieve. Absolute settings may be used to override the priority verification system and may allow default mandatory events to be defined and may allow related information to be retrieved.

For example, if the user 113 is typically interested in live feed data 127 and analytics data 125, those portions of data will be retrieved, and other data will not. This leads to increased efficiencies in data transfer and processor cycles in the database 120, as less data will be accessed and less data will be transferred. Various events, inputs, or contextual elements may act as triggers for data retrieval. Once a trigger has occurred, and the priority verification system 106 has determined that the appropriate level of priority exists, the data is retrieved. Thus, the priority verification system 106 can act as a gatekeeper, determining when the priority level 117 is high enough for event 116 to warrant retrieval of stored data 121 in the database 120.

The data evaluation system 107 of computer system 101 is configured to evaluate the event 116 using the retrieved data. Thus, in cases where the priority level 117 for the event 116 is high enough to warrant the retrieval of associated data 121, the event data structure generator 108 of the data evaluation system 107 evaluates the event 116 to create an event data structure 109. The event data structure 109 provides one or more portions of relevant contextual information 110 associated with the specified event. The relevant contextual information 110 is a subset of the stored data 121. Thus, the data evaluation system 107, in conjunction with the data relevance evaluator 111, may determine which contextual information 110 is important to the user 113 and which is most relevant to the user. The data evaluation system 107 may then access that subset of data to be included in the event data structure 109.

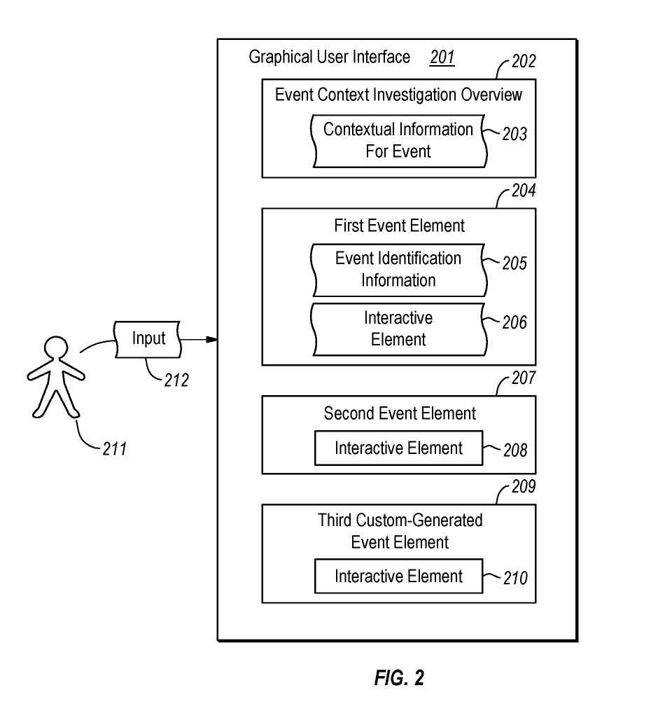

Accordingly, in some cases, based on the determined level of relevancy 112, the relevant contextual information 110 may include portions of weather data 124, logistics data 126 and live feed data 127, while in other cases, the relevant contextual information 110 may include traffic data 122 and historical data 123. Indeed, it will be understood that the relevant contextual information 110 may include substantially any subset (or all) of the stored data 121. This data may be combined and displayed in various ways, as will be shown in FIGS. 2-5. The event data structure generator 108 creates an event data structure 109 for the relevant contextual information 110, and stores the data structure internally, on the database 120, or in some other location. Additionally or alternatively, the event data structure 109 may be passed or transmitted to other modules within the computing system 101 or to computing systems external to computing system 101.

For example, the event data structure 109 with its corresponding relevant contextual information 110 may be electronically sent to the provisioning module 128 of computing system 101. The provisioning module 128 may be configured to provide the created event data structure 109 to at least one entity such as user 113 (i.e. to the user's mobile device 114 or to another computer system associated with the user), or to a company or governmental entity. The event data structure 109 may be displayed on the display of the mobile device 114, or may be combined with other data structures to form a larger data structure that is usable by other applications to present or incorporate the relevant contextual information 110 of the event. In some cases, as will be described further below in FIG. 2, the event data structure 109 may be displayed in a first event GUI element 204, with associated event identification information (e.g. time 118 and location 119), as well as an interactive element 206 that allows the first element 204 to be selected by a user 211.

In some embodiments, a configurable baseline portion of data may be associated with each event. This baseline data may include the time 118 of the event or the time span of the event, and the location 119 of the event, or any other information that may be associated with the event. The time and location data may represent information that is associated with the occurrence of each event, although they do not need to be noted if such is desirable. As mentioned above, other contextual data associated with the event 116 may be stored in a data store such as database 120. Some of that data may be retrieved for each event that has a sufficient threshold level of priority 117 (i.e. is determined to be of sufficient importance to the user 113). The retrieved data is the relevant contextual information 110. That information may itself have a determined level of relevancy, and may be presented to the user 113 according to the level of relevancy 112. Indeed, when events occur, each event may be filtered by its determined level of relevancy. Various relevancy classifications may be established into which events are categorized. In one example, the relevancy classifications may include graded levels such as “low relevancy,” “medium relevancy,” and “high relevancy.” Many other relevancy classifications may be used.

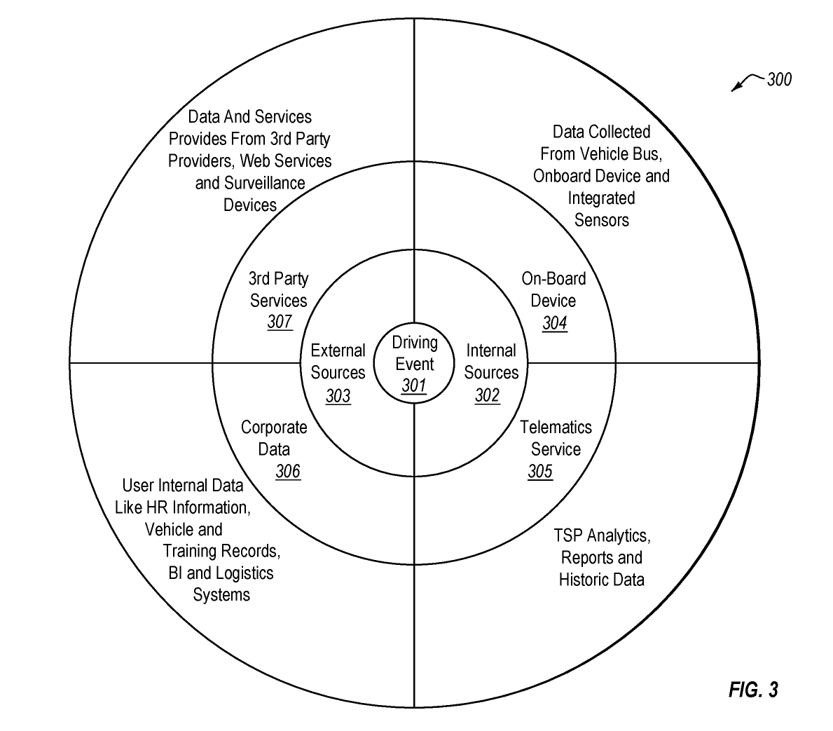

As shown in FIG. 3, the stored data 121 of FIG. 1 may come from one or more of a variety of different sources. In FIG. 3, the data is associated with a driving event 301, although it will be understood that substantially any type of event including a world news event, a sporting event, a weather event, a criminal event, health-related event or any other type of event. The data may be retrieved from one or more local or distributed databases, including internal sources 302 such as on-board devices 304 (e.g. data collected from a vehicle's internal software, on-board devices such as video cameras, or on-board sensors including piezoelectric sensors, gyroscopes, or other sensors).

Additionally or alternatively, the data may be retrieved from an internal source 302 such as a telematics service 305. Such data may include analytics (e.g. 125), reports, historic data (e.g. 123), etc. Still further, the data may be from external sources 303 and may include corporate data 306 such as user internal data (e.g. human resources information), vehicle and training records, business intelligence and logistics systems (e.g. 126), etc., or may be from third party services 307 including third party web services, third party surveillance devices such as intersection cameras, etc. Thus, it can be seen that the type and/or source of data for the stored data 121 of FIG. 1 may be virtually unlimited. This data may be parsed and prepared for presentation in various forms, including in GUI 201 of FIG. 2.

FIG. 2 includes graphical user interface 201, which may be instantiated on a computer system such as mobile device 113 of FIG. 1. The computer system may store and/or have access to a computer program product that includes computer storage media having stored thereon computer-executable instructions that, when executed by a hardware processor of the computer system, cause the computer system to instantiate a graphical user interface 201 that includes an event context investigation overview 202 that allows users to view and evaluate contextual information related to an event.

For instance, user 211 may provide one or more inputs 212 indicating that the user would like to view certain portions of contextual information related to an event. The event context investigation overview 202 may present many different portions of information (e.g. stored data 122 from FIG. 1) related to an event (e.g. 116). The contextual information 203 may be displayed on a touchscreen GUI or within an application on a desktop computer that allows touch or mouse inputs. Regardless of the input types, the user 211 may provide inputs 212 that select various portions of that information. Indeed, each event may multiple event elements associated therewith. Thus, the GUI 201 may present contextual information related to many different events, and each event may have one or many different event elements.

Each of the event elements may have its own interactive elements. For instance, the GUI 201 may include a first event element 204 that represents a certain event such as a traffic accident. The first event element 204 has information identifying the event (i.e. event identification information 205), as well as an interactive element 206 that allows user interaction. For example, the interactive element 206 may be a button, a check box, a data entry field or any other selectable element that allows user interaction. The GUI 201 may further include a second event element 207 that includes interactive elements such as interactive element 208. The interactive element 208 allows the user 211 (e.g. a fleet manager) to drill down into contextual information displayed in the event element to identify additional contextual information related to the event.

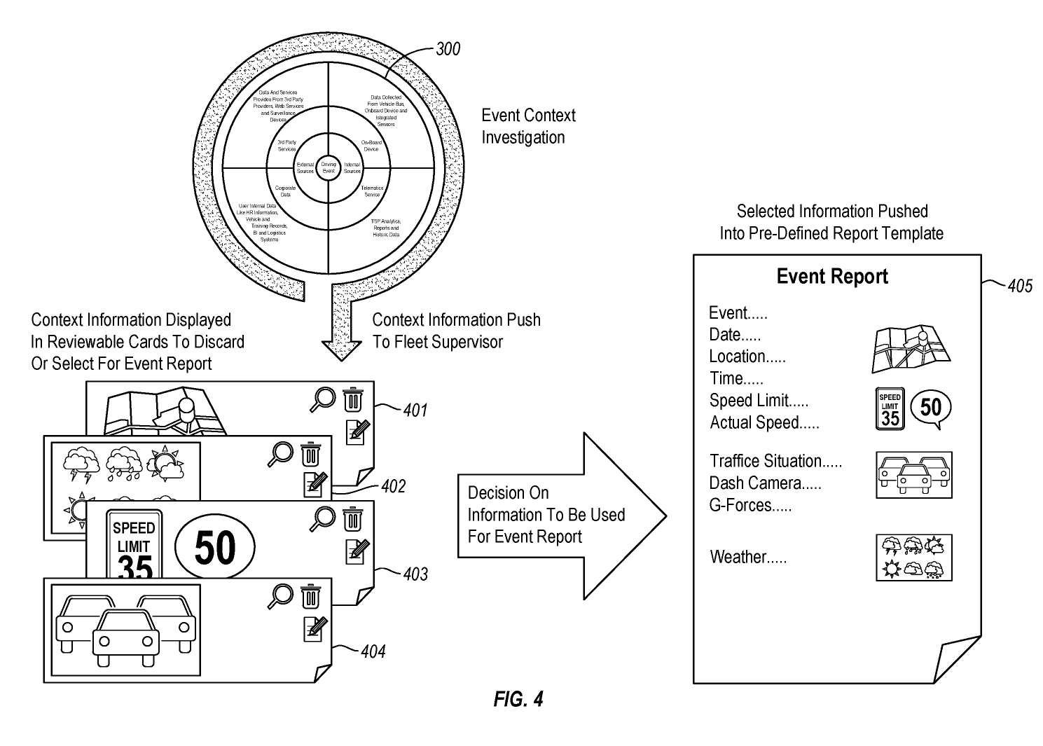

Thus, at least in some embodiments, the interactive elements (e.g. 206 and 208) may allow further interaction with other elements. For instance, as will be described in greater detail with regard to FIG. 4, each interactive element may allow selection of that element to learn more about that event. If, for example, an event element is displayed that provides weather data related to the event, the user 211 may select the interactive element within the event element to drill down into that information.

At a high level, the weather may simply indicate the type of weather that was being experienced in the city where the event took place. Drilling down may provide more detailed information including wind speed, humidity, precipitation levels, or even live-feed data showing the weather of the actual location where the event occurred at the time of the event. The detailed information may allow for specialists to model or analyze the event situation in a post-event analysis in a similar manner. This analysis may be based on the same or even more accurate data (e.g. because weather samples are taken closer to the time of the event) than is normally used in pre-situation predictions and modeling (e.g. forecast and prediction modeling of black ice, fog, rain or other weather situations).

Similarly, other event elements may provide different types of data (e.g. any of stored data 121 available in database 120 or available through third parties), and different levels of granularity for that data. Thus, the user 211 can interact with the GUI 201 to drill down into the lower layers of data when interested in that data.

Over time, the computer system tracks inputs 212 provided by the user 211 to determine which event elements (e.g. 204) are selected by the user and which contextual information 203 is determined to be relevant to the user. This allows future event elements to be custom generated for the user based on the tracked inputs. For instance, as shown in FIG. 2, a third custom-generated event element 209 may be generated for display in GUI 201. The element 209 may be generated for the user 211 after tracking the user's inputs over a period of time. For instance, the computer system may determine that the user almost always selects analytics data, and within the analytics data, usually selects a particular type of statistical analysis. In such cases, the third custom-generated event element 209, along with its corresponding interactive element 210, may include the user-preferred statistical analysis. Then, when a certain type of event appears and is presented to the user, the user 211 does not need to drill down from a higher level analytics event element to access the preferred statistical analysis because it is already there as the custom-generated event element 209.

In some embodiments, one or more of the event elements representing the event may be a reviewable card. As shown in FIG. 4, for example, reviewable cards 401-404 may be generated and presented to a user in a GUI such as GUI 201 of FIG. 2. As can be seen in FIG. 4, the data from the various internal and external sources (i.e. stored data 121 of FIG. 1) may be accessed and used to generate the reviewable cards. In FIG. 4, the reviewable cards 401-404 are generated in response to a vehicle traffic-related event. It is to be understood, however, that the reviewable cards may be generated for any type of event, and that the theme of traffic events has been maintained for consistency in understanding.

Thus, at least in some cases, the first, second, third (or whatever number of event elements have been created (e.g. event elements 204, 207 and 209 of FIG. 2) may correspond to the reviewable cards 401, 402 and 403. The reviewable cards may have one or more interactive elements that allow a user to drill down into contextual information displayed in the reviewable card to identify additional contextual information related to the event. If the event is a driving event (301), the first reviewable card 401 may show logistics data such as a map. The reviewable cards may include graphics, text, video or any other UI elements that visually depict to the user the kind of information provided by that card. The reviewable card 401 includes a search button (indicated by the magnifying glass), a trash button that deletes the card (indicated by the trash can) and a details button (indicated by the pencil and paper) that allows the user to discover additional details related to the event.

Many different reviewable cards may be presented to the user in the user interface. Reviewable card 402, for example, provides weather information, as indicated by the rain, cloud and sunshine graphics. Reviewable card 403 provides speed limit information and/or vehicle speed information, as indicated by the speed limit sign. Reviewable card 404 provides traffic data, as indicated by the picture of the three vehicles. Each of these pictures, graphics and text may be customized by the user to their liking. In some cases, the interactive elements on the reviewable cards may include a forward button that allows users to forward the reviewable card to one or more other users, or send or select the card to be embedded in any form of report. For instance, user 211 may think that a specific reviewable card is noteworthy, especially for a given event. The user may, in such cases, forward the reviewable card to another user via email, text message or some other information transfer means.

Additionally or alternatively, the interactive elements of the reviewable cards may include a save button that allows users to save the reviewable card in a data store. For instance, a user may wish to save one or more of reviewable cards 401-404, in relation to a particular event. Those reviewable cards may be saved in the database 120 or in some other data store. The reviewable cards may be saved in a manner that links the cards to a specific event or group of events. As such, the user may build up a collection of reviewable cards related to different events, which can be accessed later when needed.

As the user builds their collection of reviewable cards, the computer system 101 (or the mobile device of the user 114) may keep track of which cards have been saved by the user, and may learn which types of information the user prefers to view and store. Over time, the user's preferences and interactions with the system may be stored in a data structure. The stored data structure may be referenced when determining whether to present data and which data to present. In some cases, one or more preset settings may be implemented for a user regarding preferences, relevancy levels, etc. As user inputs are received over time, the preset settings may be modified according to learned user preferences.

These learned preferences may also provide a level of relevancy (e.g. 112 of FIG. 1) for each type of information. The learned preferences may then be used to generate customized reviewable cards that are specific to the user, for each event or type of event. In some cases, the reviewable cards may be stacked in a list, as shown in FIG. 4. The computer system 101 may continually generate and provide new reviewable cards to the user. The user then interacts with the card in some form including saving the card, forwarding the card, deleting the card, or drilling down into the card to discover additional contextual information related to an event.

As the user selects different cards, an event report 405 may be generated based on which reviewable cards are selected. The event report 405 may include a pre-defined report template which is populated with information from the selected reviewable cards (e.g. 401-404). The event report 405 shown in FIG. 4 may include event information, date information, location, time, speed limit, actual vehicle speed, traffic situation, dash camera footage, g-force information, weather information or other types of information. The information in the event report 405 may be presented as text, graphics, video or in some other form. The event report 405 may include information for a single event or for multiple events (e.g. information for events that are related to or similar to the current event).

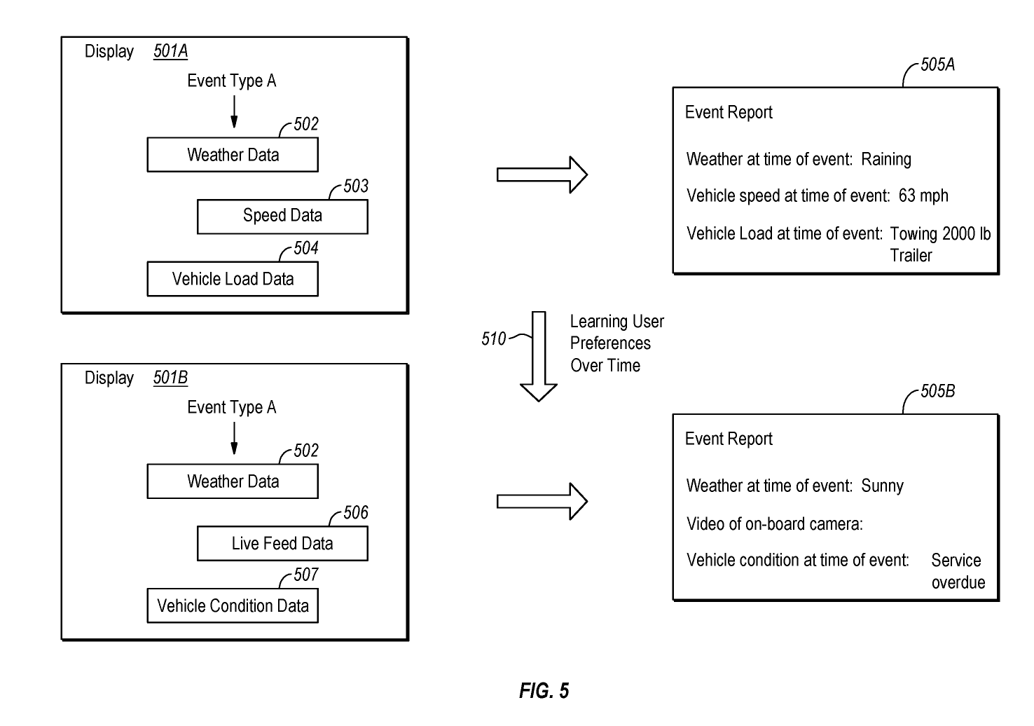

FIG. 5 illustrates how information in an event report may change over time as the system learns the user's preferences. Display 501A shows event elements 502, 503 and 504 for event type A. These event elements may be similar to or the same as event elements 204, 207 and 209 of FIG. 2. These event elements may represent reviewable cards that have been presented to a user, or they may represent reviewable cards that have already been selected by the user. As such, the corresponding event report 505A may include weather data 502 (in this case, an indication that the weather was rainy at the time of the event), speed data 503 indicating that the vehicle's speed at the time of the event was 63 mph, and vehicle load data 504, indicating that the vehicle was towing a 2,000 pound trailer at the time of the event.

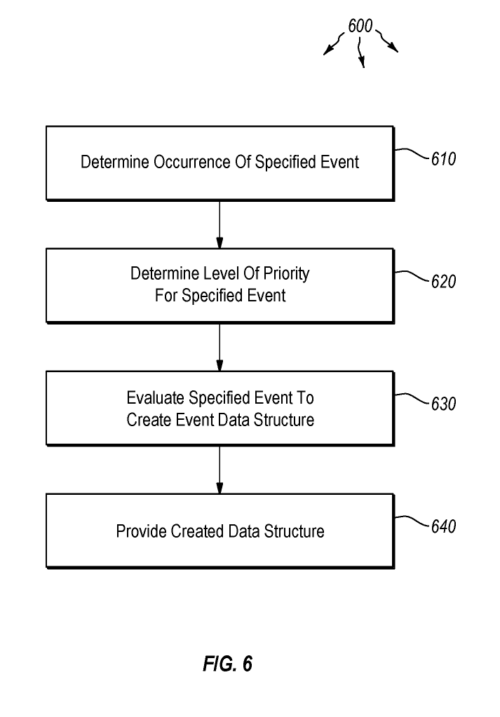

This initial event report 505A may be displayed to the user with little to no learning of the user's preferences. Over time, the computer systems and embodiments described herein are capable of learning the user's preferences (510). As such, after time has passed, a different event report may be generated, even though the same event type has occurred. Indeed, FIG. 5 shows that in display 501B, weather data 502, live feed data 506, and vehicle condition data 507 are shown when the same event type A has occurred. In this case, the system has learned that the user prefers to view weather data, live feed data and vehicle condition data when events of event type A occur. The corresponding event report 505B thus include weather data indicating that the weather was sunny at the time of the event, live feed data providing a video from the on-board camera of a vehicle, and vehicle condition data 507 indicating that the vehicle that crashed, or was caught running a red light, etc. was overdue for service at the time of the event. Thus, it can be seen that the systems herein can learn a user's preferences over time based on their selections, and can generate different reports over time for the same event or the same event type. These concepts will be explained further below with regard to method 600 of FIG. 6.

In view of the systems and architectures described above, methodologies that may be implemented in accordance with the disclosed subject matter will be better appreciated with reference to the flow chart of FIG. 6. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 6 illustrates a flowchart of a method 600 for providing event context assistance. The method 600 will now be described with frequent reference to the components and data of environment 100 of FIG. 1, as well as components of FIGS. 2-5.

Method 600 includes detecting the occurrence of at least one specified event, wherein the specified event has an associated level of priority (610). For example, the event detector 105 may detect that event 116 has occurred. The event 116 has an associated priority level 117 and potentially other information including the time 118 of the event and the location 119 of the event. The priority verification system 106 determines that the level of priority 117 for the specified event 116 is sufficient to trigger retrieval of data 121 from one or more data stores (e.g. 120) (620). If the priority level 117 is at least a threshold minimum amount, the computer system 101 will request the transfer of data from the database 120. If the priority level does not meet this threshold minimum, then data will not be retrieved. This can save processing resources as well as bandwidth resources between the database 120 and the computer system 101.

Method 600 further includes evaluating the specified event 116 using the retrieved data to create an event data structure 109 that provides one or more portions of relevant contextual information 110 related to the specified event (630). The event data structure generator 108 may generate the event data structure 109 once the data evaluation system has evaluated the data retrieved from the database 120. The event data structure 109 includes contextual information 110 that is relevant to the event 116. A data relevance evaluator 111 may be used to determine the level of relevancy 112 for a given event. The level of relevancy 112 may be specific to a given user, as each user may assign different weigh to different types of contextual information. This level of relevancy 112 may be refined and honed over time as the user provides inputs to the system, selecting different types of information for different events.

Method 600 also includes providing the created event data structure 109 to at least one entity (640). The provisioning module 128 of computer system 101 may provide the event data structure 109 to user 113 via the mobile device or via some other computer system. The event data structure may be transferred to other computer systems via a wired or wireless computer network, and may be displayed on a monitor or touchscreen, allowing user interaction therewith.

As mentioned above, the contextual information 110 may include substantially any type of information that is useful to the user 113 and is in any way related to the event. The contextual information 110 may be a subset of the entire set of information stored in the database or in external or third party databases. The contextual information 110 may include historical data 123 including driver behavior, vehicle utilization, driver license status, driving history (e.g. number of past tickets), driver education status (e.g. whether the driver has taken advanced educational or practical driving courses), weather data 124, traffic data 122, analytics data 125, logistics data 126, live feed data 127 (e.g. camera surveillance video, traffic light status, on-board telematics data from vehicles, etc.), corporate data (e.g. from a fleet of vehicles), data from third party services, or other types of data which may be useful in providing context for an event.

In some cases, the provisioning module 128 may provide the generated data structure 109 to at least one entity by presenting the data structure on a display (e.g. display 501A of FIG. 5). The generated data structure 109 may include interactive user interface elements (e.g. 206, 208 or 210 of FIG. 2) that allow users to access additional information about the specified event. The user 113 may, for example, select the interactive element 206 for a first event element 204. The graphical user interface in which the interactive element is displayed may display new interactive elements that show additional contextual information related to the event 116. As the user drills down into a given type of contextual information, more detailed information of that type may be provide. In some cases, the contextual information may include multiple different types of data from the database 120. The determination as to which types of data to bring in for display to the user may depend on the relevancy of the data.

The data relevance evaluator 111 of the computer system 101 may determine a level of relevancy 112 for the contextual information 110 related to the specified event. The level of relevancy 112 may be based on which information the user has viewed in the past, which information the user has saved in the past, which information the user has forwarded or shared with other users in the past, or based on other interactions with the stored data 121. In some cases, the level of relevancy 112 for the contextual information 110 may be determined using indications of which contextual information was relevant to prior events. For example, if the weather was bring and sunny during an event, the weather may not be relevant, whereas if the weather was foggy or snowy, weather may be highly relevant if the event is an automobile accident. Accordingly, the level of relevancy may be based on factors other than user interaction. Indeed, the level of relevancy may be based on the data itself and how objectively relevant it is to the event.

In one embodiment, at least one indication of which contextual information 110 was relevant to a prior event includes an indication of user behavior at a prior event. The system may show representations of what the user has actually selected in the past. The relevancy is thus not determined by the user's position or role or which keywords the user has chosen to receive information about, but rather what the user's behavior has been relative to a given event or type of event in the past. The database 120 may thus keep a record of direct customer preferences based on their selections, as well as inferred customer preferences that are learned over time. The database 120 may store these preferences for a variety of different users, and may apply user preferences to each individual as they use the system to discover contextual information related to an event.

It should be noted that the user's behavior may include all types of interaction with the computer system 101 and/or with their mobile device 114. For example, identifying user behavior related to an event may include identifying which email messages the user looked at, which databases the user accessed, which websites they viewed, which reports the user read, etc. Over time, the system may learn that, for instance, user 113 only cares about drastic changes in weather that cause vehicles not to arrive on time. As such, the relevancy level for weather information, and specifically weather changes that cause vehicles not to arrive on time, is increased. This level of relevancy 112 for that portion of contextual information 110 may be continually refined over time. As such, different event data structures may be provided to the user 113 according to the refined level of relevancy for the contextual information 110.

Continuing this example, when reports are generated, the user 113 would receive a report that emphasized the weather data (or included solely weather data). In this manner, each of a plurality of users may receive a different customized report regarding the same event. Each user will receive a customized report based on their user-specific level of relevancy for each portion of the contextual information. These personalized reports will help the user to quickly and easily view those types of contextual information that are most helpful to that user for that event.

In the embodiment shown in FIG. 4, the event data structure includes data that is presentable in a GUI as reviewable event cards 401-404. The reviewable cards have interactive elements that allow a user to drill down into contextual information displayed in the event card to identify additional contextual information related to the event. Each reviewable event card may also include an identifier (e.g. 205) that is unique to the event. In such cases, each reviewable event card may include an identifier to show that it is connected to or associated with the event. The reviewable event cards may include graphics that are designed to be easily readable at a glance. For instance, reviewable event card 403 shows that the speed limit was 35, while the user's speed was 50 mph. Other graphics, for weather for example, may simply show a raincloud or a sun to show the type of weather. These graphics and text may be large and easy to understand at a glance, and then provide the user the ability to drill down into that information further if so desired.

In some cases, the user may be able to specify a user-defined event. In such cases, the user receives relevant contextual information related to the user-defined event. Such event types may include accident events, delivery events, doctor check-up events, traffic law violation events, non-traditional weather events, or other types of events as specified by the user. If the user is only interested in where the event occurred, that is all the user will see on the reviewable card(s). If the user is solely interested in the event only if video footage is available, the user will not be notified of the event unless video footage is available. Regardless of what the event is, the systems described herein will determine which information to show to the user and how best to show it. If the user is interested in further information, they may simply interact with a reviewable event card or other interactive user interface element to learn more about that event.

Accordingly, methods, systems and computer program products are provided which provide event context assistance. The methods, systems and computer program products learn a user's preferences over time and intelligently provide relevant contextual information to the user in easily readable forms that also allow the user to dig deeper if desired.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A method, implemented at a computer system that includes at least one hardware processor, for providing event context assistance, the method comprising:
detecting the occurrence of at least one specified event, wherein the specified event has an associated level of priority;
determining that the level of priority for the specified event is sufficient to trigger retrieval of data from one or more data stores;
evaluating the specified event using the retrieved data to create an event data structure that provides one or more portions of relevant contextual information related to the specified event; and
providing the created event data structure to at least one entity.

2. The method of claim 1, wherein the specified event further includes an associated time and location.

3. The method of claim 1, wherein the data retrieved from the one or more databases comprises at least one of historical data, weather data, traffic data, analytics data, logistics data or live feed data.

4. The method of claim 1, wherein providing the created data structure to at least one entity further comprises presenting the created data structure on a display, the created data structure including one or more interactive user interface elements that allow users to access additional information about the specified event.

5. The method of claim 1, further comprising determining a level of relevancy for the contextual information related to the specified event.

6. The method of claim 5, wherein the level of relevancy for the contextual information is determined using one or more indications of which contextual information was relevant to prior events.

7. The method of claim 6, wherein at least one of the indications of which contextual information was relevant to prior events comprises an indication of user behavior at a prior event.

8. The method of claim 7, wherein the user behavior related to the prior event comprises identifying which email messages the user looked at, which databases they accessed, which websites they viewed, or which reports the user read.

9. The method of claim 6, wherein the level of relevancy for the contextual information is continually refined over time, such that different event data structures are provided to the user according to the refined level of relevancy for the contextual information.

10. The method of claim 9, wherein a plurality of users each receives a different customized set of reviewable cards regarding the same specified event based on a user-specific level of relevancy for the contextual information, the reviewable cards being implemented to build a report.

11. A computer program product comprising one or more computer storage media having thereon computer-executable instructions that, when executed by one or more hardware processors of a computing system, cause the computing system to instantiate a graphical user interface comprising the following:
an event context investigation overview that allows users to view and evaluate contextual information related to an event;
a first event element representing the event, the first event element having information identifying the event; and
at least a second event element that includes one or more interactive elements that allow a user to drill down into contextual information displayed in the event element to identify additional contextual information related to the event,
wherein the computer system tracks inputs provided by the user to determine which event elements are selected by the user and which contextual information is determined to be relevant to the user, allowing future event elements to be custom generated for the user based on the tracked inputs.

12. The computer program product of claim 11, wherein the first event element representing the event comprises a reviewable card, the reviewable card having one or more interactive elements that allow a user to drill down into contextual information displayed in the reviewable card to identify additional contextual information related to the event.

13. The computer program product of claim 12, wherein at least one of the interactive elements on the reviewable card comprises a forward button that allows a user to forward the reviewable card to one or more other users or to directly embed the information into a specified report.

14. The computer program product of claim 12, wherein at least one of the interactive elements of the reviewable card comprises a save button that allows a user to save the reviewable card in a data store.

15. The computer program product of claim 12, wherein the computer system tracks which interactive elements are selected to determine which event elements and which interactive elements are most relevant to the user.

16. The computer program product of claim 11, wherein the first and second event elements are both related to the same event.

17. A computer system comprising the following:
one or more processors;
a communications module comprising a hardware transceiver;
an event detector configured to detect the occurrence of at least one specified event, wherein the specified event has an associated level of priority;
a priority verification system configured to determine that the level of priority for the specified event is sufficient to trigger retrieval of data from one or more databases;
a data evaluation system configured to evaluate the specified event using the retrieved data to create an event data structure that provides one or more portions of relevant contextual information related to the specified event; and
a provisioning module configured to provide the created event data structure to at least one entity.

18. The computer system of claim 17, wherein the event data structure includes a plurality of reviewable event cards, the reviewable cards having one or more interactive elements that allow a user to drill down into contextual information displayed in the event card to identify additional contextual information related to the event, the reviewable event cards further including an identifier that is unique to the event.

19. The computer system of claim 17, wherein the contextual information related to the specified event comprises at least a portion of information related to a driver of a vehicle, and at least a portion of information related to the condition of the vehicle.

20. The computer system of claim 17, wherein the specified even comprises a user-defined event, such that the user receives relevant contextual information related to the user-defined event.
